(19) United States
(12) Patent Application Publication
(10) Pub. No.: US 2009/0213745 A1
(43) Pub. Date: Aug. 27, 2009

(54) FRAME MONITORING DEVICE AND FRAME MONITORING METHOD

(75) Inventor: Kazuaki YOSHIDA, Fukuoka (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/390,502

(22) Filed: Feb. 23, 2009

(30) Foreign Application Priority Data
Feb. 21, 2008 (JP) 2008-040636

(51) Int. Cl. H04L 12/26

(52) U.S. Cl. 370/252

(57) ABSTRACT

One aspect of the embodiments utilizes a frame monitoring device includes a monitoring period judging unit for judging whether the period of a received frame is a monitoring period satisfying a condition for detecting the alarm and a received frame input control unit for inputting a new frame received by the frame monitoring device into the buffer when the new frame is received and it is judged by the monitoring period judging unit that the period of the frame is the monitoring period satisfying the alarm detecting condition, and discarding the new frame without inputting the frame into the buffer when it is judged by the monitoring period judging unit that the period of the frame is a monitoring period which does not satisfy the alarm detecting condition.

### CROSS-REFERENCE TO RELATED APPLICATIONS

This application is based upon and claims the benefit of priority of the prior Japanese Application No. 2008-40636, filed on Feb. 21, 2008, the entire contents of which are incorporated herein by reference.

### FIELD

The embodiment relates to a frame monitoring device for receiving a frame for checking connectivity between each outward-facing device every period and for detecting an alarm when the received frame is not sequentially input to a buffer for a given period.

### BACKGROUND

There has been disclosed a technique for monitoring frames received and transmitted among respective communication devices in a network (for example, Ethernet (registered trademark) or the like) utilizing a conventional IP network and for detecting a congestion state, abnormality, or the like in the network to help reduce or prevent an increase of traffic (see JP-A-7-226762).

A wide-area Ethernet (registered trademark) using a layer 2 of Ethernet (registered trademark) is mounted mainly in an L2VPN (Layer 2 Visual Private Network) of a P2P connection (Point-to-Point) or multipoint connection. In general, “Y.1731” by ITU-T (International Telecommunication Union Telecommunication-Standardization Sector) is standardized as a technique for maintenance, management, etc. of various events occurring in the layer 2. Furthermore, Ethernet—OAM (Ethernet (registered trademark)—Operations Administration and Maintenance) for which standardization work has been developed as “IEEE802.1ag” in IEEE (The Institute of Electrical and Electronics Engineers, Inc) has been recently used.

The Ethernet (registered trademark)—OAM performs the maintenance and management, etc. of various events occurring in the layer 2 by using the CC (Continuity Check) function, the LB (LoopBack) function, and/or the LT (Link Trace) function, etc. Particularly, the CC function is a function of checking connectivity and continuity of a logical line path between an outward-facing device and an in-ward facing device. The CC function is implemented by receiving a CCM (Continuity Check Message) frame transmitted from a plurality of outward-facing devices at fixed periods and by performing frame monitoring such as a check of arrival or non-arrival of the CCM frame within a fixed time, a parameter comparison in the CCM frame, etc. Furthermore, in the Ethernet (registered trademark)—OAM, a group to be managed is called an “MEG” (Maintenance Entity Group), and a terminal device in an MEG is called an “MEP” (MEG End Point). MEG is an assembly of sections in which various kinds of tests (check of connectivity, etc.) are implemented by using frames, and an MEP is located at the terminal (end) point of an MEG to generate and terminate (import) the frames used for implementing failure management and performance measurement.

Here, the frame monitoring processing using the CCM frame described above will be described with reference to FIG. 10. FIG. 10 is a diagram illustrating the frame monitoring processing according to the prior art. For example, as illustrated in FIG. 10, the frame monitoring device receives a CCM frame from one of a plurality of outward-facing devices (outward-facing MEP=1) every period (for example, “1 period”). The frame monitoring device detects an alarm (non-reception alarm) when it does not receive any CCM frame sequentially within a given period (for example, “3 periods”). Furthermore, the non-reception alarm is recovered (non-reception alarm recovery) when the frame monitoring device detects the CCM frame sequentially for the given period “3 periods”. The frame monitoring device transmits/receives CCM frames between a plurality of outward-facing devices while repeating the monitoring processing of the transmitted/received CCM frames.

However, the above-described technique has a problem that a buffer having a large capacity is required to be mounted.

Specifically, it is difficult to synchronize the transmission timing among the devices in the Ethernet (registered trademark) network. The frame monitoring device processes the CCM frames transmitted from the outward-facing devices without dropping any CCM frames, and thus it is preferable to perform the CCM frame reception processing while the total line capacity is set as the maximum speed. As a result, this technique has a problem that a buffer having a large capacity is required to be mounted. Furthermore, when no large-capacity buffer is mounted, there is a problem that the overflow of unintentional discard of CCM frames from a buffer may occur, and thus an alarm (non-reception alarm) may occur.

### SUMMARY

According to an aspect of an embodiment, a frame monitoring device receives from each of a plurality outward-facing devices a frame for checking connectivity between each of the outward-facing devices every period and detects an alarm when the received frame is not input to the buffer sequentially for a given period. The frame monitoring device includes a monitoring period judging unit for judging whether the period of the frame is a monitoring period satisfying a condition for detecting the alarm at or subsequent to the period after a period of a frame input from each of the outward-facing devices into a buffer after the received frame is input to the buffer without detecting any alarm; and a received frame input control unit for inputting a new frame into the buffer when the new frame is received by the frame monitoring device and when the monitoring period judging unit judges that the period of the frame is the monitoring period satisfying the alarm detecting condition, and discarding the frame without inputting the frame into the buffer when the monitoring period judging unit judges that the period of the frame is a monitoring period which does not satisfy the alarm detecting condition.

Additional objects and advantages of the embodiment will be set forth in part in the description which follows, and in part will be obvious from the description, or may be learned by practice of the invention.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a diagram illustrating the outline and feature of a frame monitoring device according to a first embodiment;

FIG. 2 is a diagram illustrating the configuration of the frame monitoring device according to the first embodiment;

FIG. 3 is a diagram illustrating an example of a CCM frame format according to the first embodiment;

FIG. 4 is a diagram illustrating an example of an MEG ID format according to the first embodiment;

FIG. 5 is a diagram illustrating an example of a discard priority flag table according to the first embodiment;

FIG. 6 is a diagram illustrating outward-facing MEP list extraction according to the first embodiment;

FIG. 7 is a flowchart illustrating frame writing processing of the frame monitoring device according to the first embodiment;

FIG. 8 is a flowchart illustrating frame read-out processing of the frame monitoring device according to the first embodiment;

FIG. 9 is a flowchart illustrating a discard priority flag renewal processing of the frame monitoring device according to the first embodiment; and

FIG. 10 is a diagram illustrating a frame monitoring processing according to a related art.

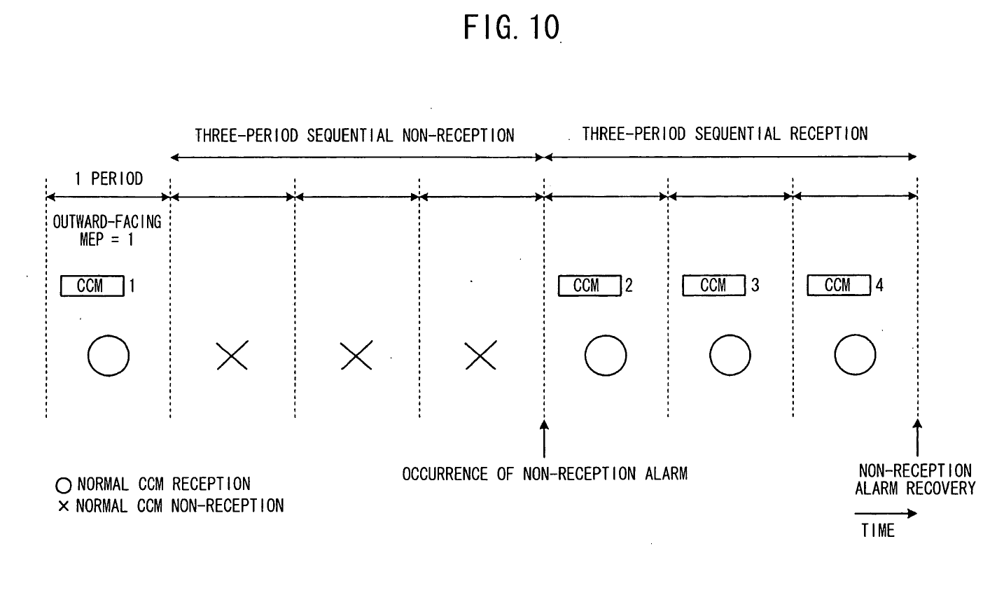

### DETAILED DESCRIPTION OF THE PREFERRED EMBODIMENTS

An embodiment of a frame monitoring device according to the present invention will be described in detail with reference to the accompanying drawings. The outline and feature of the frame monitoring device according to the present invention, the configuration of the frame monitoring device and the processing flow will be described in order, and the effect of the embodiment will be finally described.

### First Embodiment

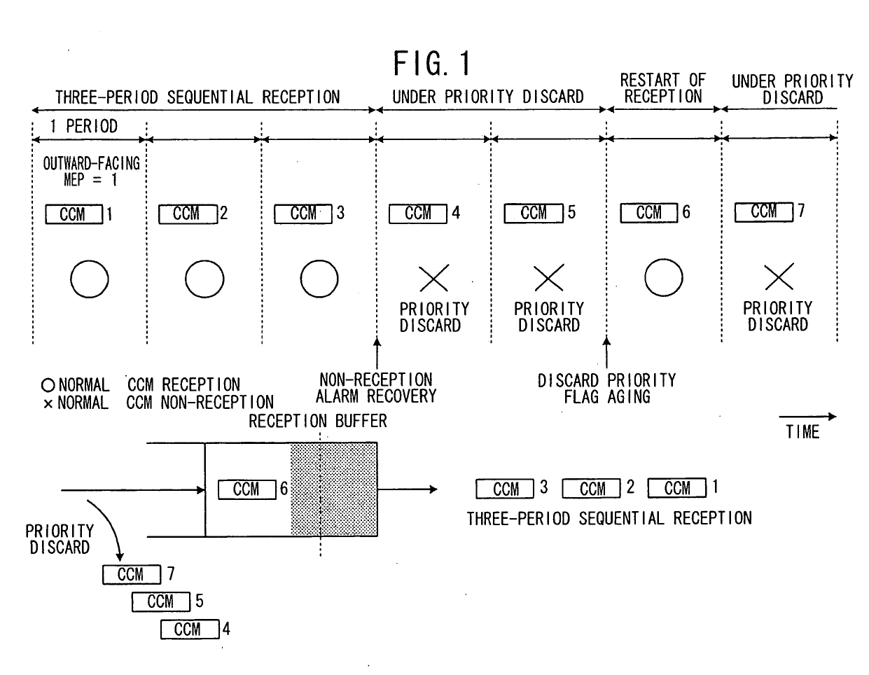

The frame monitoring device according to a first embodiment will be first described with reference to FIG. 1. FIG. 1 is a diagram illustrating the outline and features of the frame monitoring device according to the first embodiment.

The frame monitoring device is connected to outward-facing devices different from the frame monitoring device, and the frame monitoring device acts as an L2 switch for checking connectivity and continuity by using frames transmitted from the outward-facing devices. Furthermore, the frame monitoring device detects a non-reception alarm when the frames transmitted from the outward-facing devices are not received even when a given time period (for example, three periods) elapses. The frame monitoring device detecting the non-reception alarm recovers the non-reception alarm when the frame monitoring deice sequentially receives the frames transmitted from the outward-facing devices for a given time period of “three periods”.

In the following description, it is assumed that a CCM frame is received from an outward-facing device 1 (outward-facing MEP=1). However, CCM frames may be received from a plurality of outward-facing devices different than the above outward-facing device 1. Here, the outline and feature of the frame monitoring device will be described, and the detailed description will be made subsequent to the description of the configuration of the frame monitoring device. It is assumed that the frame monitoring device receives a CCM frame 1, a CCM frame 2, and a CCM frame 3 and then a non-reception alarm is recovered, so that the frame monitoring device is in a state that it can normally receive CCM frames.

In this state, the frame monitoring device receives frames for checking connectivity between outward-facing devices every period, and detects an alarm when the received frames are not sequentially input to a buffer for a given time period. Particularly, the present invention is mainly characterized in that a sufficient buffer resource can be ensured without mounting any large-capacity buffer.

The main feature of the present invention will be specifically described. After frames received from outward-facing devices are input to the buffer without detecting any alarm, the frame monitoring device judges whether the period of the frame is a monitoring period satisfying a condition for detecting the alarm at or subsequent to the period after the period at which the frame is received and input to the buffer.

Describing a specific example, when a CCM frame 1 (first period), a CCM frame 2 (second period), and a CCM frame 3 (third period) received from the plurality of outward-facing devices are input to the buffer sequentially for three periods without detecting any alarm, and then a new frame “CCM frame 4” is received at or subsequent to the period after (fourth period) the period input to the buffer (third period), the frame monitoring device judges whether the fourth period is a monitoring period satisfying a condition for detecting an alarm (for example, whether non-reception is continued for three periods).

When the new frame is received by the frame monitoring device and also the period of the new frame is judged to be a monitoring period satisfying the alarm detecting condition, the new frame is input into the buffer. On the other hand, when period of the new frame is a monitoring period which does not satisfy the alarm detecting condition, the new frame is not input to the buffer, but discarded.

Specifically, when the CCM frame 4 is received by the frame monitoring device and the period of the CCM frame 4 is judged to be a monitoring period which does not satisfy the alarm detecting condition (e.g., non-reception is not continued for three periods), the frame monitoring device does not input the CCM frame 4 into the buffer, but discards the CCM frame 4. When a CCM frame 5 is received by the frame monitoring device and the period of the CCM frame 5 is judged to be a monitoring period which does not satisfy the alarm detecting condition (e.g., non-reception is not continued for three periods), the frame monitoring device does not input the CCM frame 5 into the buffer, but discards the CCM frame 5 as in the case of the CCM frame 4.

Subsequently, when a CCM frame 6 is received by the frame monitoring device and the period of the CCM frame 6 is judged to be a monitoring period satisfying the alarm detecting condition (non-reception is continued for three periods), the frame monitoring device inputs the CCM frame 6 into the buffer. Thereafter, when a CCM frame 7 is received and the period of the CCM frame 7 is judged to be a monitoring period which does not satisfy the alarm detecting condition (non-reception is not continued for three periods), the frame monitoring device does not input the CCM frame 7 into the buffer, but discards the CCM frame 7.

As described above, in the case where an alarm is detected when the frame monitoring device according to the first embodiment receives, from the plurality of outward-facing devices, frames for checking the connectivity between the plurality of outward-facing devices every period and an alarm is detected when the frame is not input to the buffer even when a given monitoring period elapses, a frame received from the plurality of outward-facing devices is input to the buffer without detecting any alarm. When the frame after the frame input to the buffer or a subsequent frame is received, the period of the frame is judged as to whether or not the period of the frame is a monitoring period satisfying the alarm detecting condition. If it is judged that the period of the frame is the monitoring period satisfying the alarm detecting condition, the frame is input to the buffer. If the period of the frame is a monitoring period which does not satisfy the alarm detecting condition, the frame concerned is not input to the buffer, but discarded. As a result, a sufficient buffer resource can be ensured without mounting a large-capacity buffer.

That is, in the case where the frame monitoring device receives a frame for checking the connectivity between the plurality of outward-facing devices every period and detects an alarm when the frame is not sequentially input to the buffer for a given monitoring period, the frames transmitted from the plurality of outward-facing devices are received. When a frame is received, the frame monitoring device discards frames corresponding to the preceding periods before the period acting as the alarm detecting condition (for example, frame non-reception is continued for three periods). Subsequently, the frame monitoring device inputs the frame corresponding to the period serving as the alarm detecting condition into the buffer. In short, the frame monitoring device inputs the received frame into the buffer or preferentially discards the received frame so that no alarm is detected. Therefore, as compared to the related art in which a large-capacity buffer is required to be mounted for a large number of frames which are asynchronously received from the plurality of outward-facing devices, a sufficient buffer resource can be ensured without mounting any large-capacity buffer. Furthermore, as compared to the related art in which a large-capacity buffer is not mounted and received frames are unintentionally discarded, in the frame monitoring device, a sufficient buffer resource can be ensured and occurrence of an alarm due to unintentional discard of frames can be reduced if not prevented.

### Configuration of Frame Monitoring Device According to First Embodiment

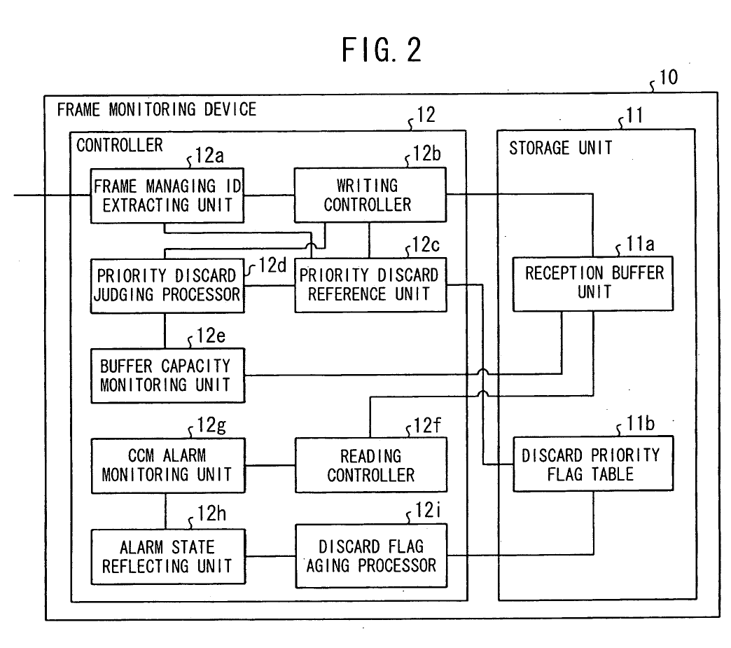

Next, the configuration of the frame monitoring device according to the first embodiment will be described with reference to FIG. 2. FIG. 2 is a diagram illustrating the construction of the frame monitoring device according to the first embodiment.

As illustrated in FIG. 2, the frame monitoring device 10 includes a storage unit 11 and a controller 12, and the frame monitoring device 10 receives a frame for checking the connectivity between a plurality of outward-facing devices different from the frame monitoring device 10 every period and detects an alarm in a case where the frame concerned is not input to the buffer even when a given monitoring period elapses.

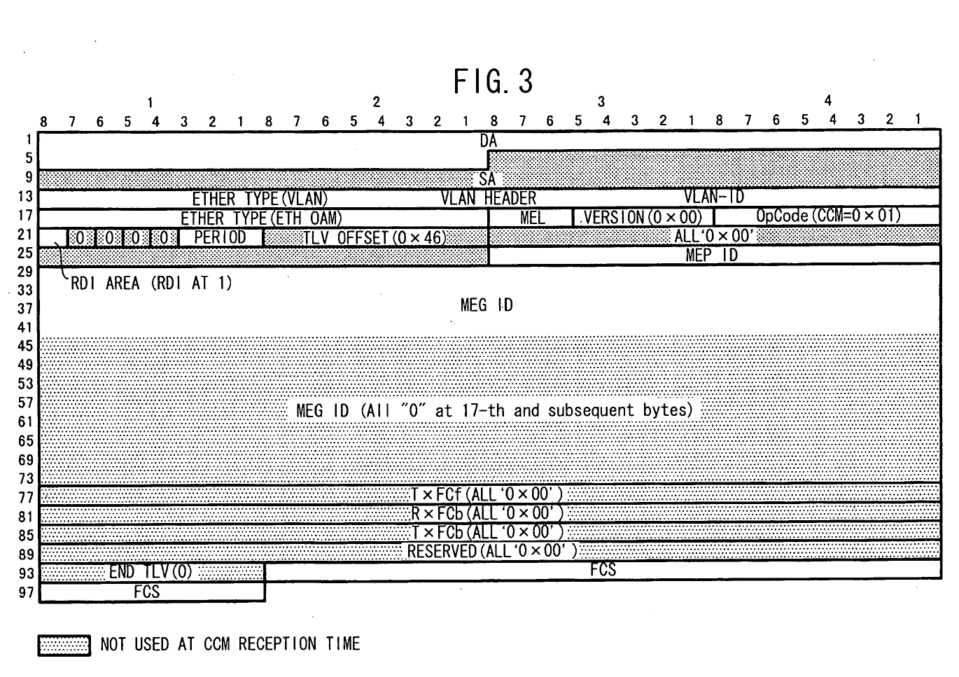

With respect to the CCM frame received from the plurality of outward-facing devices, as shown in FIG. 3, the lower 4 bits are automatically set by MEG Level, and the CCM frame is configured by a multicast address set as DA for OAM or “DA” representing a destination MAC address (unicast) set in units of MEP, “SA” representing a sending source MAC address of a transmission source MEP, “VLAN” representing a VLAN value allotted with the transmission source MEP, “EtherType” representing EtherType set as EtherType for OAM, “MEL” representing MEG Level of the transmission source MEP, “Version (0x00)” representing version information of the frame, “OpCode(0x01: CCM)” representing code information of the frame, “Period(1s:4, 10s:5, 60s:6)” representing the transmission/reception interval of the CCM frame, “MEPID” representing MEPID of the transmission source MEP, “MEGID” representing MEGID of the transmission source MEP, etc. FIG. 3 is a diagram illustrating an example of the CCM frame format according to the first embodiment.

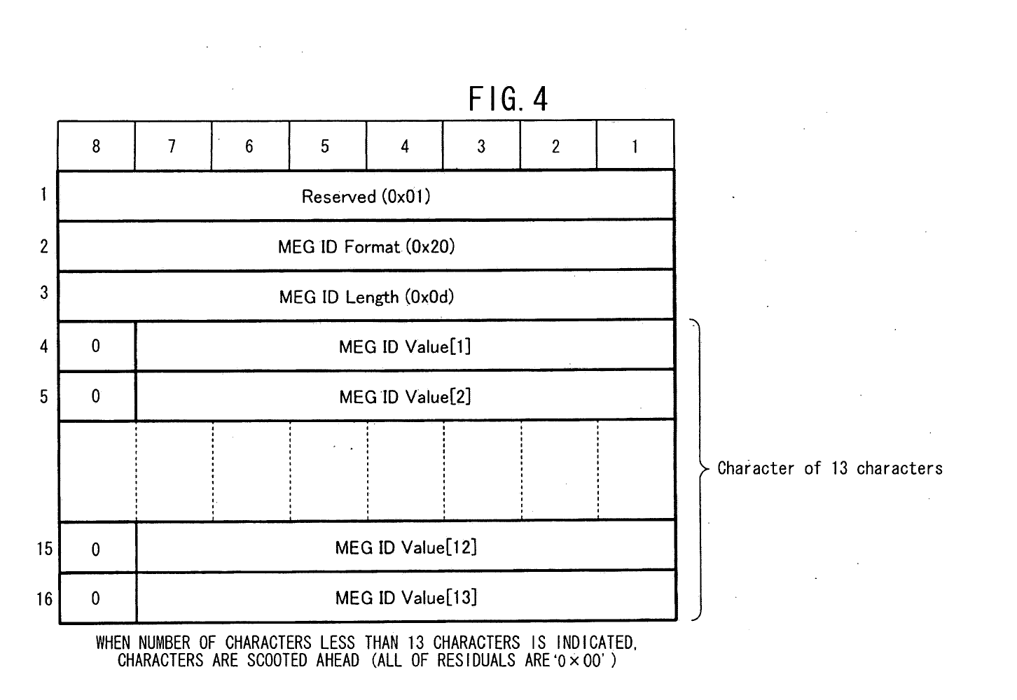

Furthermore, with respect to the format of MEGID shown in FIG. 3 which is used in transmission/reception of CCM frames, definitions are made by ITU-T and IEEE as shown in FIG. 4. In the format of “ICC-based Format” defined by “ITU-T Y.1731 ANNEX A”, only 16 bytes out of the MEGID area of 48 bytes are used, and all the remaining bytes are set to “0” (FIG. 4 shows the details of 16 bytes). FIG. 4 is a diagram illustrating an example of the format of MEGID according to the first embodiment.

The storage unit 11 stores data required for various kinds of processing executed by the controller 12 and various kinds of processing results obtained by the controller 12. The storage unit 11 is equipped with a reception buffer unit 11a and a discard priority flag table 11b as units which are closely related to the present invention.

The reception buffer unit 11a stores frames received by the frame monitoring device 10. For example, the reception buffer unit 11a temporarily buffers CCM frames transmitted from a plurality of outward-facing devices connected to the frame monitor device 10.

In association with identification information (outward-facing MEP index) for identifying each of a plurality of outward-facing devices, the discard priority flag table 11b holds a discard priority flag (1/0) indicating whether a frame received from each of the plurality of outward-facing devices may be discarded or not, and period information indicating which period the frame received from each of the plurality of outward-facing devices corresponds to.

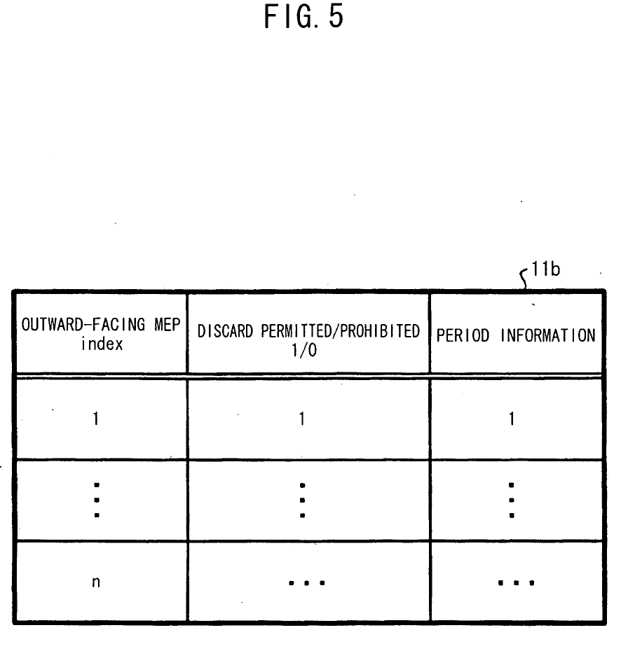

For example, as shown in FIG. 5, in association with “outward-facing MEPindex: 1” representing identification information for identifying each of the plurality of outward-facing devices, the discard priority flag table 11b holds “discard priority flag (discard-permitted: 1/discard-prohibited:0) representing whether the frame received from each of the plural outward-facing devices can be discarded or not, and “period information: 1” representing a period to which the frame received from each of the outward-facing devices corresponds. FIG. 5 shows an example of the discard priority flag table 11b according to the first embodiment.

The controller 12 has an internal memory for storing a control program, programs defining various kinds of processing procedures, etc., and required data, and has a frame managing ID extracting unit 12a, a writing controller 12b, a priority discard reference unit 12c, a priority discard judging processor 12d, a buffer capacity monitoring unit 12e, a reading controller 12f, a CCM alarm monitoring unit 12g, an alarm state reflecting unit 12h, and a discard flag aging processor 12i as elements which are particularly closely related to the present invention. Various kinds of processing are executed by these elements.

The frame managing ID extracting unit 12a extracts management information associated with the logical line path stored in the frame and converts the extracted management information to an outward-facing MEP list serving as an alarm management unit of the CCM frame.

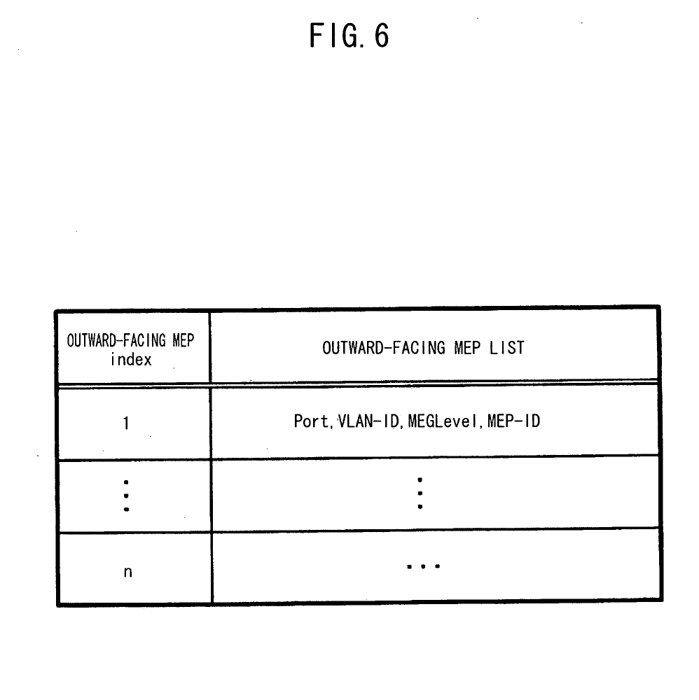

For example, as shown in FIG. 6, the frame management ID extracting unit 12a extracts management information “Port”, “VLAN-ID”, “MEGLevel” and “MEP-ID” associated with the logical line path stored in the CCM frame received from each of the plurality of outward-facing devices. The frame management ID extracting unit 12a executes the conversion to the outward-facing MEP list as the alarm management unit of the CCM frame received from each of the plurality of outward-facing devices for every outward-facing device to generate information on which the discard priority flag table shown in FIG. 5 is based. Subsequently, the frame management ID extracting unit 12a notifies the priority discard reference unit 12c of the generated outward-facing MEP list. FIG. 6 is a diagram to explain the outward-facing MEP list extraction according to the first embodiment.

The writing controller 12b stores the frame received by the frame monitoring device 10 into the reception buffer unit 11a and notifies the priority discard reference unit 12c described later of the completion of the writing, or the writing controller 12b discards the frame without storing the frame in the reception buffer unit 11a.

For example, the writing controller 12b stores in the reception buffer unit 11a a plurality of CCM frames which are transmitted from a plurality of outward-facing devices and are received by the frame monitoring device 10. The writing controller 12b which stores the CCM frames in the reception buffer unit 11a notifies the priority discard reference unit 12c of the completion of the writing. Furthermore, for example, when the priority discard judging processor 12d (described later) judges that a received CCM frame can be discarded, the writing controller 12b preferentially discards the CCM frame concerned without storing the CCM frame in the reception buffer unit 11a.

The priority discard reference unit 12c generates an address of the discard priority flag table 11b on the basis of the outward-facing MEP list notified by the frame management ID extracting unit 12a, reads out the discard priority flag corresponding to the received frame, and notifies the priority discard judging processor 12d (described later) as to whether the frame concerned can be discarded or not.

For example, the priority discard reference unit 12c generates the corresponding address in the discard priority flag table 11b on the basis of the outward-facing MEP list “Port” information, “VLAN-ID” information, “MEG-Level” information, and “MEP-ID” information corresponding to the CCM frame which is notified and received by the frame management ID extracting unit 12a. The priority discard reference unit 12c reads out the discard priority flag “discard-permitted: 1/discard-prohibited: 0” of the outward-facing device corresponding to the generated address from the discard priority flag table 11b, and notifies the priority discard judging processor 12d as to whether the received CCM frame can be discarded or not.

Furthermore, when the writing controller 12b notifies the reception buffer unit 11a that the frame writing processing is completed, the priority discard reference unit 12c generates the address of the discard priority flag table 11b corresponding to the frame on which the writing processing has been completely executed, and renews the discard priority flag of the frame to “discard-permitted”.

For example, the writing controller 12b notifies the reception buffer unit 11a that the CCM-frame writing process is completed, the priority discard reference unit 12c generates the corresponding address in the discard priority flag table 11b on the basis of the outward-facing MEP list “Port” information, “VLAN-ID” information, “MEG-Level” information, and “MEP-ID” information corresponding to the CCM frame the writing processing on which the writing processing has been completed. The priority discard reference unit 12c renews the discard priority flag of the outward-facing device corresponding to the generated address to “discard-permitted: 1”. The discard priority flag of the CCM frame written in the reception buffer unit 11a is renewed as “discard-permitted: 1” so that CCM frames received from the period after the writing into the reception buffer unit 11a till the period before the monitoring period serving as the alarm detecting condition (for example, non-reception continues for three periods) are discarded and the buffer resource of the reception buffer unit 11a is effectively used.

The priority discard judging processor 12d determines frame-discard permission or frame-discard non-permission on the basis of the permission or non-permission of frame discard notified by the priority discard reference unit 12c, and notifies the writing controller 12b. For example, when the CCM frame is notified as “discard-permitted: 1” by the priority discard reference unit 12c and also is notified by the buffer capacity monitoring unit 12e (described later) that the frame discard threshold value of the reception buffer unit 11a is equal to or greater than the threshold value, the priority discard judging processor 12d outputs a discard instruction signal of the CCM frame to the writing controller 12b.

Furthermore, for example, when the CCM frame is notified to be “discard-prohibited: 0” by priority discard reference unit 12c or it is notified by the buffer capacity monitoring unit 12e (described later) that the frame discard threshold value of the reception buffer unit 11a is less than a threshold value, the priority discard judging processor 12d does not output the discard instruction signal of the CCM frame concerned to the writing controller 12b. When the reception buffer 11a is equal to or more than the frame discard threshold value and also satisfies physically a buffer capacity, storing further CCM frames in the reception buffer unit 11a is difficult, and thus the CCM frames are discarded unconditionally.

The buffer capacity monitoring unit 12e monitors the capacity of the reception buffer 11a, and judges whether the capacity of the buffer concerned is equal to or more than a given threshold value. For example, the buffer capacity monitoring unit 12e monitors the buffer capacity of the reception buffer unit 11a, and when a number of frames exceeding a frame discard threshold corresponding to a threshold value at which frame discard is required is stored in the reception buffer unit 11a, the priority discard judging processing 12d is notified that the frame exceeds the frame discard threshold value.

The reading controller 12f successively executes the reading processing of frames stored in the reception buffer unit 11a, and transmits the read-out frames to a CCM alarm monitoring unit 12g described later. For example, the reading controller 12f successively executes the reading processing of the CCM frames that corresponds to the plurality of outward-facing devices which are written and stored in the reception buffer unit 11a by the writing controller 12b. The reading controller 12f transmits the read-out CCM frames to the CCM alarm monitoring unit 12g.

The CCM alarm monitoring unit 12g executes the CCM alarm monitoring processing on the frames transmitted by the reading controller 12f for every outward-facing device, and performs the terminating processing of the frames. For example, the CCM alarm monitoring unit 12g executes the CCM alarm monitoring processing on the CCM frame transmitted by the reading controller 12f for every outward-facing MEP. Then, the CCM alarm monitoring unit 12g executes the terminating processing on the CCM frame which has been subjected to the CCM alarm monitoring processing. When detecting the CCM frame of the outward-facing MEP satisfying the alarm condition, the CCM alarm monitoring unit 12g notifies the alarm state reflecting unit 12h described later.

The alarm state reflecting unit 12h requests to the discard flag aging processor 12i described later to conduct renewal processing (described later) of the discard priority flag of the frame of the corresponding outward-facing device on the basis of the alarm detection information informed by the CCM alarm monitoring unit 12g. For example, the alarm state reflecting unit 12h requests to the discard flag aging processor 12i to conduct the renewal processing of the discard priority flag of the frame of the corresponding outward-facing MEP on the basis of the CCM frame detection information of the outward-facing MEP satisfying the alarm condition notified by the CCM alarm monitoring unit 12g.

The discard flag aging processor 12i executes the renewal processing of the corresponding discard priority flag on the basis of the renewal processing request of the discard priority flag requested by the alarm state reflecting unit 12h. For example, the discard flag aging processor 12i renews the corresponding discard priority flag of the discard priority flag table 11b to “discard-prohibited: 0” on the basis of the renewal processing request of the discard priority flag requested by the alarm state reflecting unit 12h. That is, when a non-reception alarm occurs, it is preferable to sequentially receive the CCM frame of the corresponding outward-facing MEP for a given period “three periods (cycles)”, and thus the discard priority flag corresponding to the CCM frame of the corresponding outward-facing MEP is prevented from being set to “discard-permitted: 1” only while the non-reception alarm occurs.

After a frame is input to the reception buffer unit 11a, the discard flag aging processor 12i judges whether the period is a period satisfying a condition for detecting an alarm which is detected when no frame is input into the buffer sequentially for a given number of periods at or subsequent to the period after the period at which the frame concerned is input.

For example, after a CCM frame is input to the reception buffer unit 11a, the discard flag aging processor 12i judges whether the period is a period satisfying the condition for detecting the alarm which is detected when no frame is sequentially input to the buffer for “three periods” at or subsequent to the period after (N+1) the period “N” at which the CCM frame is input. The discard flag aging processor 12i renews the discard priority flags of the discard priority flag table 11b corresponding to the CCM frames of the period “N+1” up to the given number of periods “3 periods” and the period “N+2” to “discard-permitted: 1”, and renews the discard priority flag of the discard priority flag tale 11b corresponding to the CCM frame of the period “N+3” to “discard-prohibited: 0”. That is, the discard flag aging processor 12i can reduce if not prevent occurrence of the CCM-frame non-reception alarm due to the frame priority discard even during buffer congestion by aging the discard priority flag of the CCM frame until a given period (3 periods) at which the CCM frame non-reception alarm occurs. The period of the aging processing can be set to any value.

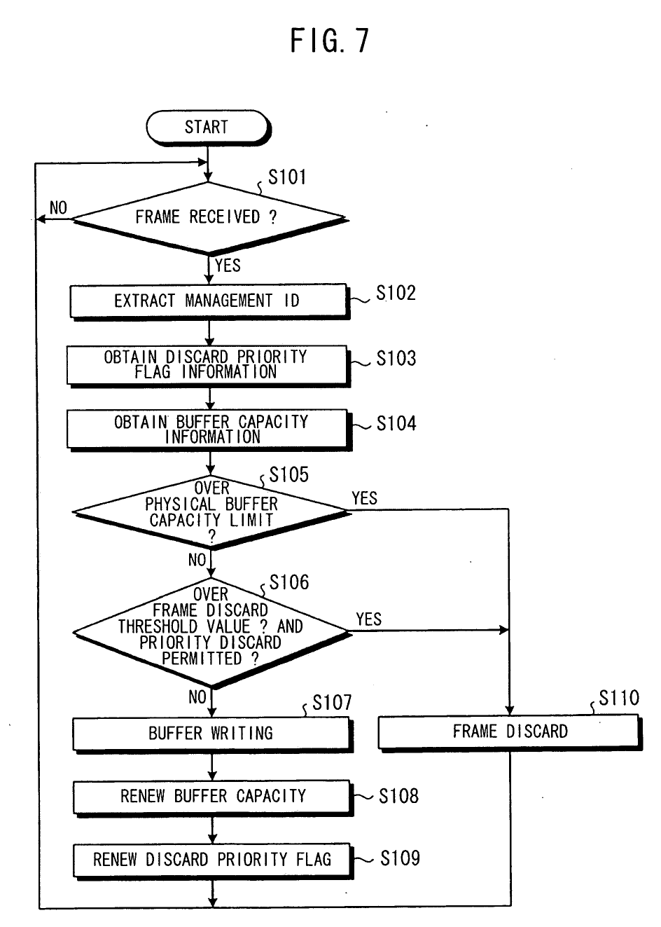

Next, the processing of the frame monitoring device 10 according to the first embodiment will be described with reference to FIGS. 7, 8 and 9 as “writing processing”, “reading processing” and “discard priority flag renewal processing”.

### Writing Processing According to First Embodiment

First, the writing processing of the frame monitoring device 10 will be described with reference to FIG. 7. FIG. 7 is a flowchart illustrating the writing processing of the frame monitoring device 10 according to the first embodiment.

As shown in FIG. 7, when the frame monitoring device 10 receives a CCM frame from each of a plurality of outward-facing devices (step S101: Yes), the frame monitoring device 10 extracts management ID information such as “Port”, “VLAN-ID”, “MEG-Level”, and “MEP-ID” of the received CCD frame and converts the information to an outward-facing MEP list (step S102).

The frame monitoring device 10 obtains the discard priority flag information corresponding to the CCM frame received from the outward-facing MEP list from the discard priority flag table 11b (step S103), and obtains present capacity information of the reception buffer unit 11a (step S104).

Subsequently, the frame monitoring device 10 judges whether the obtained capacity information of the reception buffer unit 11a physically exceeds a capacity limit (step S105). If the capacity does not exceed the capacity limit (step S105: No), the frame monitoring device 10 judges whether the reception buffer unit 11a exceeds a frame discard threshold value with respect to the obtained capacity information and also whether the obtained discard priority flag is “discard-permitted: 1” (step S106).

Thereafter, the frame monitoring device 10 writes the received CCM frame into the reception buffer unit 11a (step S107) when the reception buffer unit 11a does not exceed the frame discard threshold value with respect to the obtained capacity information or when the obtained discard priority flag is “discard-prohibited: 0” (step S106: No).

The frame monitoring device 10 renews the capacity information to “capacity=present amount+1” (step S108) because the received CCM frame is written into the reception buffer unit 11a, and renews the discard priority flag and the period information of the discard priority flag table 11b corresponding to the CCM frame to “discard-permitted: 1” and “N+1 (present period N)” (step S109).

Furthermore, when the capacity information exceeds the capacity limit in step S105 (step S105: Yes), the frame monitoring device 10 discards the CCM frame concerned because the reception buffer unit 11a cannot store any more CCM frames (step S110). When the reception buffer unit la exceeds the frame discard threshold value with respect to the obtained capacity information and the obtained discard priority flag is “discard-permitted: 1” in step S106 (step S106: Yes), the frame monitoring device 10 discards the CCM frame concerned to effectively use the resources of the reception buffer unit 11a (step S110). When the CCM frame is discarded in step S110, the capacity information of the reception buffer unit 11a is not renewed (capacity=present amount).

### Reading Processing According to First Embodiment

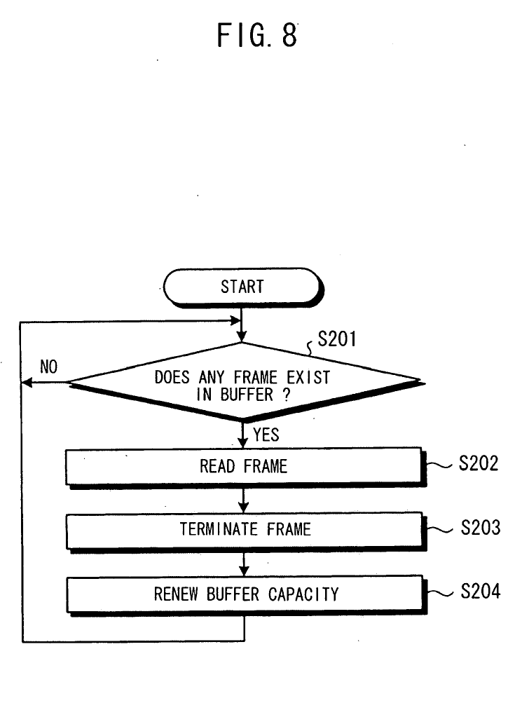

Next, the reading processing of the frame monitoring device 10 according to the first embodiment will be described with reference to FIG. 8. FIG. 8 is a flowchart illustrating the reading processing of the frame monitoring device 10 according to the first embodiment.

As illustrated in FIG. 8, when the reception buffer unit 11a stores CCM frames from a plurality of outward-facing devices (step S201: Yes), the frame monitoring device 10 successively reads out the CCM frames (step S202), and executes the terminating processing of the read-out CCM frames (step S203).

The frame monitoring device 10 renews the capacity information of the reception buffer unit 11a “capacity=present amount−1” when the terminating processing of the CCM frame is executed (step S204). When there is no CCM frame stored in the reception buffer unit 11a in step S201 (step S201: No), the capacity information of the reception buffer unit 11a holds the present capacity without any renewal (capacity=present amount).

### Discard Priority Flag Renewal Processing According to First Embodiment

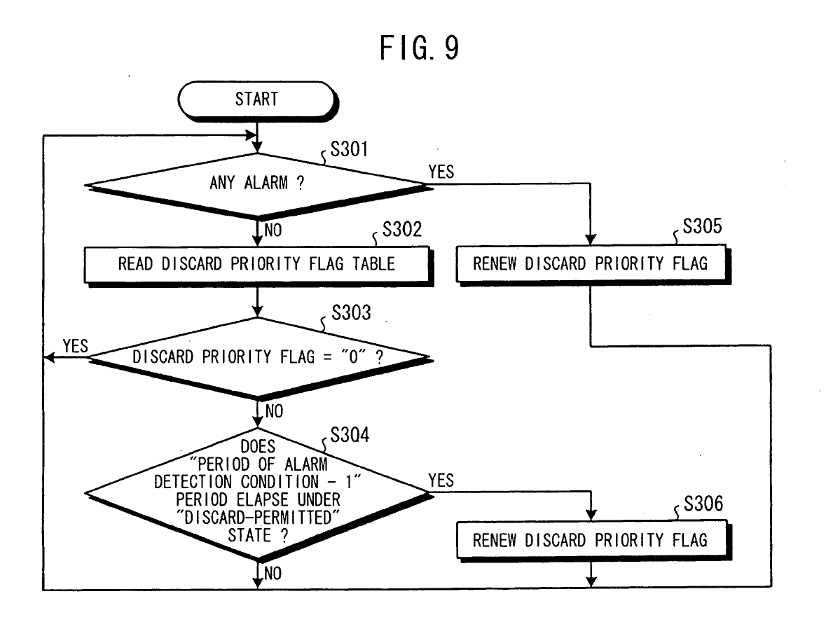

Next, the discard priority flag renewal processing of the frame monitoring device 10 according to the first embodiment will be described with reference to FIG. 9. FIG. 9 is a flowchart illustrating the discard priority flag renewal processing of the frame monitoring device 10 according to the first embodiment.

As illustrated in FIG. 9, when a CCM frame is transmitted every period, a non-reception alarm, which would occur if no CCM frame is input to the buffer sequentially for a given period “three periods”, is monitored. When the alarm is not detected (step S301: No), the frame monitoring device 10 reads out the discard priority flag and the period information stored in the discard priority flag table 11b (step S302).

When the read-out discard priority flag is discard-permitted “1” (step S303: No), the frame monitoring device 10 judges on the basis of the read-out period information whether the period of “three periods−one period=two periods” serving as the alarm detecting condition elapses or not (step S304). If the two periods elapse (step S304: Yes), the corresponding discard priority flag stored in the discard priority flag table 11b is renewed to discard-prohibited “0” (step S306).

Furthermore, when an alarm is detected in step S301 (step S301: Yes), the frame monitoring device 10 unconditionally renews the discard priority flag stored in the discard priority flag table 11b to discard-prohibited “0” (step S305).

When the discard priority flag read out in step S303 is the “discard-prohibited: 0” (step S303: Yes), the discard priority flag stored in the discard priority flag table 11b is not renewed, and it is kept as “discard-prohibited: 0”. When the two periods do not elapse in step S304 (step S304: No), the discard priority flag stored in the discard priority flag table 11b is not renewed, but kept as “discard-permitted: 1”.

### Effect of First Embodiment

As described above, according to the first embodiment, in a case where the frame monitoring device 10 receives a frame for checking the connectivity between each of a plurality of outward-facing devices from each of the plurality of outward-facing devices every period and detects an alarm when the received frame is not input to the buffer sequentially for a given number of periods, frame monitoring device 10 judges whether a detection condition of an alarm which occurs when a frame from each of the plurality of outward-facing devices is input to the buffer and then no frame is input to the buffer during a given period is satisfied or not. If the alarm detecting condition is satisfied, the frame is input to the buffer, and if the alarm detecting condition is not satisfied, the frame is not input to the buffer, but discarded. Therefore, instead of mounting a large-capacity buffer, a sufficient buffer resource can be ensured. That is, the frame monitoring device 10 discards the frame corresponding to a period at which no alarm is detected, and inputs into the buffer the frame corresponding to a period at which an alarm is detected. Therefore, a sufficient buffer resource can be ensured without mounting a large-capacity buffer. Furthermore, the frame monitoring device 10 can ensure a sufficient buffer resource, so that an alarm caused by unintentional frame discard can be reduced if not prevented.

For example, when a CCM frame is input to the reception buffer unit 11a in the first period, the frame monitoring device 10 judges whether a CCM frame has not yet been received sequentially for three periods, which is the alarm detecting condition, at or subsequent to the second period. The frame monitoring device 10 discards the CCM frames received at the second and third periods because the second and third periods are periods which do not satisfy the alarm detecting condition. Subsequently, the fourth period is a period satisfying the alarm detecting condition, and thus the frame monitoring device 10 inputs the CCM frame received at the fourth period into the reception buffer unit 11a. As a result, a sufficient buffer resource can be ensured without mounting any large-capacity buffer, and also an alarm caused by unintentional frame discard can be reduced if not prevented.

### Second Embodiment

The present invention is not limited to the above embodiment, and various modifications and alterations may be made to the embodiment. Another embodiment will be described below.

[Configuration of Frame Monitoring Device]

The procedures, the control procedures, and information containing specific names, various kinds of data, parameters (for example, information such as items, numerical values, etc. stored in “discard priority flag table 11b” as shown in FIG. 2) may be arbitrarily changed unless particularly specified.

Furthermore, the respective constituent elements of each device shown in the figures are functional and conceptual, and it is unnecessary that they are configured physically as shown in the figures. That is, the specific styles of distribution and integration of the respective devices are not limited to those shown in the figures. For example, the CCM alarm monitoring unit 12g and the alarm state reflecting unit 12h may be integrated into the alarm monitoring processing, or the frame terminating processing and the alarm monitoring/reflecting unit for executing the renewal processing request of the discard priority flag may be integrated. That is, all or some of the devices may be configured to be functionally or physically distributed or integrated in any unit in accordance with various kinds of loads, the use state, or the like. Furthermore, with respect to each processing function executed in each device, all or any part of the processing function may be implemented by a CPU and a program analyzed and executed by the CPU, or implemented as hardware based on wired logic.

According to the frame monitoring device disclosed in this application, there can be achieved an effect that a sufficient buffer resource can be ensured without mounting a large-capacity buffer.

Furthermore, in the first embodiment, the frame monitoring device 10 executes various processings as an L2 switch for transmitting/receiving CCM frames asynchronously from the plurality of outward-facing devices. However, the present invention is not limited to this embodiment. For example, any device may be used as the frame monitoring device 10 insofar as it has a unique protocol for transmitting/receiving frames asynchronously such as CCM frames, and the device may be a network which can transmit/receive the frames concerned.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A frame monitoring device for receiving from each of a plurality of outward-facing devices a frame for checking connectivity between each of the plurality of outward-facing devices every period and for detecting an alarm when the received frame is not input to the buffer sequentially for a given number of periods, comprising:
a monitoring period judging unit for judging whether a period of a received frame is a monitoring period satisfying a condition for detecting the alarm at or subsequent to the period after a period of a frame received from an outward-facing device and input into a buffer after the received frame is input to the buffer without detecting any alarm; and
a received frame input control unit for inputting a new frame received by the frame monitoring device into the buffer when the new frame is received and the monitoring period judging unit judges that the period of the frame is the monitoring period which satisfies the alarm detecting condition, and discarding the new frame without inputting the frame into the buffer when the monitoring period judging unit judges that the period of the frame is a monitoring period which does not satisfy the alarm detecting condition.

2. The frame monitoring device according to claim 1, further comprising a discard priority flag holding unit for holding, in association with information that identifies the plurality of outward-facing devices, a discard priority flag indicating whether a frame received from each of the plurality of outward-facing devices can be discarded or not, and for holding period information indicating a period of the frame received from each of the plurality of outward-facing devices,
wherein the monitor period judging unit renews the discard priority flag of each of the plurality of outward-facing devices held in the discard priority flag holding unit so that the discard priority flag can be discarded after a frame received from each of the plurality of outward-facing devices is input to the buffer without detecting any alarm, renews the period information held in the discard priority flag holding unit when a new frame is received at or subsequent to the period after the period at which the received frame is input to the buffer, and also judges whether the period of the new frame is the monitoring period which satisfies an alarm detecting condition;
and the received frame input control unit inputs a new frame into the buffer when the new frame is received by the frame monitoring device and the monitoring period judging unit judges that the period of the new frame is the monitoring period which satisfies the alarm detecting condition, discards the new frame without inputting the new frame into the buffer when the monitoring period judging unit judges that the period of the new frame is the monitoring period which does not satisfy the alarm detecting condition, and discards the new frame without inputting the new frame into the buffer and renews the discard priority flag of each of the plurality of outward-facing devices held in the discard priority flag holding unit so that the discard priority flag cannot be discarded when the monitoring period judging unit judges that the period of the new frame is a period before a period which satisfies the alarm detection condition.

3. The frame monitoring device according to claim 2, further comprising a buffer capacity judging unit for monitoring the capacity of the buffer and judging whether the capacity of the buffer is equal to or more than a given threshold value, wherein the received frame input control unit inputs a new frame into the buffer when the new frame is received by the frame monitoring device and the monitoring period judging unit judges that the period of the new frame is a monitoring period which satisfies the alarm detecting condition; discards the new frame without inputting the new frame into the buffer when the monitoring period judging unit judges that the frame is a monitoring period which does not satisfy the alarm detection condition, when the discard priority flag of each of the plurality of outward-facing devices held in the discard priority flag holding unit can be discarded, and when the capacity of the buffer is judged to be equal to or more than a given threshold value by the buffer capacity judging unit; and discards the new frame without inputting the new frame into the buffer and renews the discard priority flag of each of the plurality of outward-facing devices held in the discard priority flag holding unit so that the discard priority flag cannot be discarded when the monitoring period judging unit judges that the period of the new frame is a period before a period which satisfies the alarm detection condition, when the discard priority flag of each of the plurality of outward-facing devices held in the discard priority flag holding unit is “discard-permitted”, and when the buffer capacity is judged to be equal to or more than the given threshold value by the buffer capacity judging unit.

4. The frame monitoring device according to claim 2 or 3, further comprising a discard priority flag controller for renewing the discard priority flag held in the discard priority flag holding unit so that the discard priority flag cannot be discarded when the alarm is detected, wherein when a new frame is received by the frame monitoring device and the discard priority flag of each of the plurality of outward-facing devices held in the discard priority flag holding unit is renewed so that the discard priority flag cannot be discarded, the received frame input control unit inputs the new frame into the buffer.

5. A frame monitoring method for a frame monitoring device that receives a frame for checking connectivity between each of a plurality of outward-facing devices from each of the plurality of outward-facing devices every period and that detects an alarm when the received frame is not input into a buffer sequentially for a given period, the method comprising:
a monitoring period judging step that judges whether the period subsequent to or after the period of the received frame that was input into the buffer is a monitoring period which satisfies the condition of detecting the alarm after the frame received from the plurality of outward-facing devices was input into the buffer without detecting an alarm; and
a received frame input control step for inputting a new frame received by the frame monitoring device into the buffer when the new frame is received and the monitoring period judging step judges that the frame is the monitoring period which satisfies the alarm detecting condition, and discarding the new frame without inputting the frame into the buffer when the monitoring period judging step judges that the period of the frame is a monitoring period which does not satisfy the alarm detecting condition.
